(19) United States
(12) Patent Application Publication
(10) Pub. No.: US 2012/0292856 A1
(43) Pub. Date: Nov. 22, 2012

(54) BLADE OUTER SEAL FOR A GAS TURBINE ENGINE HAVING NON-PARALLEL SEGMENT CONFRONTING FACES

(75) Inventors: Brian R. Pelletier, Berwick, ME (US); Paul M. Lutjen, Kennebunkport, ME (US)

(73) Assignee: UNITED TECHNOLOGIES CORPORATION, Hartford, CT (US)

(21) Appl. No.: 13/108,562

(22) Filed: May 16, 2011

(51) Int. Cl. F16J 15/16

(52) U.S. Cl. 277/345

(57) ABSTRACT

A blade outer air seal for a gas turbine engine includes an arcuate first seal segment and an arcuate second seal segment. The first seal segment extends circumferentially to a first confronting face. The second seal segment extends circumferentially to a second confronting face. The first confronting face is positioned adjacent the second confronting face defining a gap therebetween. The confronting faces are radially non-parallel at a first engine operating point where each seal segment has a first temperature distribution profile and a first pressure distribution profile. The confronting faces are substantially radially parallel at a second engine operating point where each seal segment has a second temperature distribution profile and a second pressure distribution profile, which second profiles are different than the first profiles.

This invention was made with government support under Contract No. N00019-02-C-3003 awarded by the United States Navy. The government may have certain rights in the invention.

### BACKGROUND OF THE INVENTION

1. Technical Field

This disclosure relates generally to a blade outer air seal for a gas turbine engine and, more particularly, to a blade outer air seal having non-parallel segment confronting faces.

2. Background Information

A typical turbine stage assembly for a gas turbine engine includes a blade outer air seal disposed between a rotor stage and a turbine assembly case. The air seal is used to prevent or reduce gas path leakage over tips of rotor blades in the rotor stage. Such an air seal typically includes a plurality of arcuate seal segments, each of which extends between opposite confronting faces. The confronting faces of adjacent seal segments are separated by an intersegment gap.

### SUMMARY OF THE DISCLOSURE

According to one aspect of the invention, a blade outer air seal is provided for a gas turbine engine. The air seal includes an arcuate first seal segment and an arcuate second seal segment. The first seal segment extends circumferentially to a first confronting face. The second seal segment extends circumferentially to a second confronting face. The first confronting face is positioned adjacent the second confronting face defining a gap therebetween. The confronting faces are radially non-parallel at a first engine operating point where each seal segment has a first temperature distribution profile and a first pressure distribution profile. The confronting faces are substantially radially parallel at a second engine operating point where each seal segment has a second temperature distribution profile and a second pressure distribution profile, which second profiles are different than the first profiles.

According to another aspect of the invention, another blade outer air seal is provided for a gas turbine engine. The air seal includes an arcuate first seal segment and an arcuate second seal segment. The first seal segment extends circumferentially to a first confronting face. The second seal segment extends circumferentially to a second confronting face. The first confronting face is positioned adjacent the second confronting face defining a gap therebetween. The gap varies radially at a first engine operating point where each seal segment has a first temperature distribution profile and a first pressure distribution profile. The gap is substantially radially uniform at a second engine operating point where each seal segment has a second temperature distribution profile and a second pressure distribution profile, which second profiles are different than the first profiles.

According to another aspect of the invention, still another blade outer air seal is provided for a gas turbine engine. The air seal includes an arcuate first seal segment and an arcuate second seal segment. The first seal segment extends circumferentially to a first confronting face. The second seal segment extends circumferentially to a second confronting face. The first confronting face is positioned adjacent the second confronting face defining a gap therebetween. The gap has a radially inner gap width and a radially outer gap width. The inner gap width is greater than the outer gap width at a first engine operating point where each seal segment has a first temperature distribution profile and a first pressure distribution profile. The inner gap width is substantially equal to the outer gap width at a second engine operating point where each seal segment has a second temperature distribution profile and a second pressure distribution profile, which second profiles are different than the first profiles.

The foregoing features and the operation of the invention will become more apparent in light of the following description and the accompanying drawings.

### BRIEF DESCRIPTION OF THE DRAWINGS

FIG. 1 is a side-sectional diagrammatic illustration of a section of a turbine stage assembly that includes a blade outer air seal.

FIG. 2 is a diagrammatic illustration of a seal segment included in the air seal shown in FIG. 1.

FIG. 3 is a diagrammatic illustration of adjacent ends of first and second seal segments included in the air seal shown in FIG. 1.

FIG. 4A is a cross-sectional, partial diagrammatic illustration of confronting faces of first and second seal segments at a first engine operating point.

FIG. 4B is a cross-sectional, partial diagrammatic illustration of the confronting faces shown in FIG. 4A at a second engine operating point.

FIG. 5A is a top view of a seal segment that is centrally supported by mounting flanges.

FIG. 5B is a top view of a seal segment that is supported by mounting flanges at its center and edges.

### DETAILED DESCRIPTION OF THE INVENTION

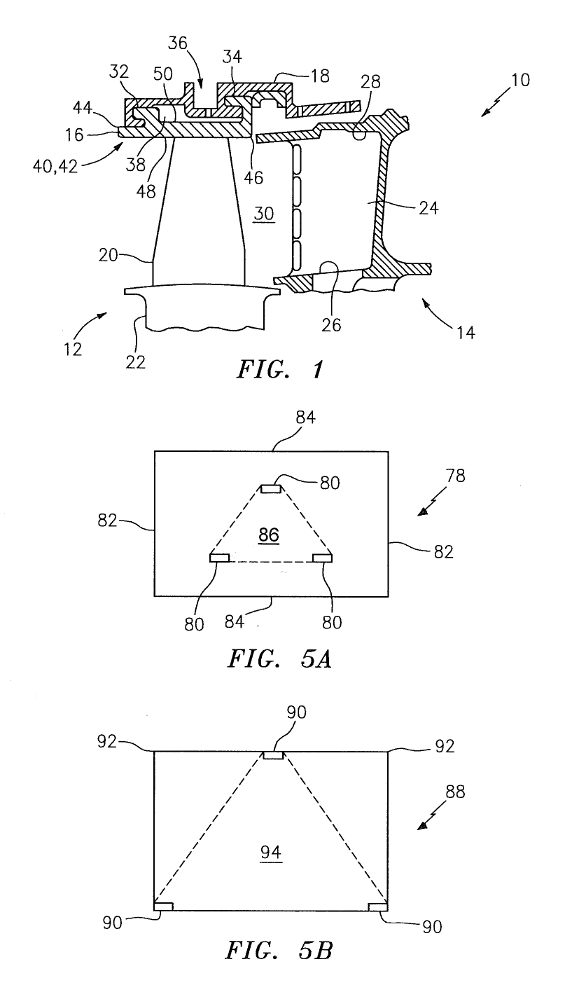

Referring to FIG. 1, a section of a turbine stage assembly 10 is shown for a gas turbine engine. The assembly 10 includes a rotor blade stage 12, a stator vane stage 14, a blade outer air seal 16 (sometimes also referred to as a “BOAS”) and a turbine support case 18. The rotor blade stage 12 includes a plurality of rotor blades 20 circumferentially disposed around a rotor disk 22. The stator vane stage 14 includes a plurality of stator vanes 24 circumferentially disposed between inner and outer vane platforms 26 and 28. The stator vanes 24 are located downstream of the rotor blades 20 in a hot gas flow path 30 (sometimes also referred to as a “working gas flow path”). The blade outer air seal 16 is located radially between the rotor blades 20 and the support case 18, and is connected to the support case 18 via a plurality of mounting flanges 32 and 34. The support case 18 houses the rotor blade stage 12, the stator vane stage 14, and the blade outer air seal 16. The support case 18 includes a cooling gas flow path 36 that is configured to allow cooling air (e.g., from a compressor section of the engine) to pass there through and into a cooling gas plenum 38 located between the blade outer air seal 16 and the support case 18.

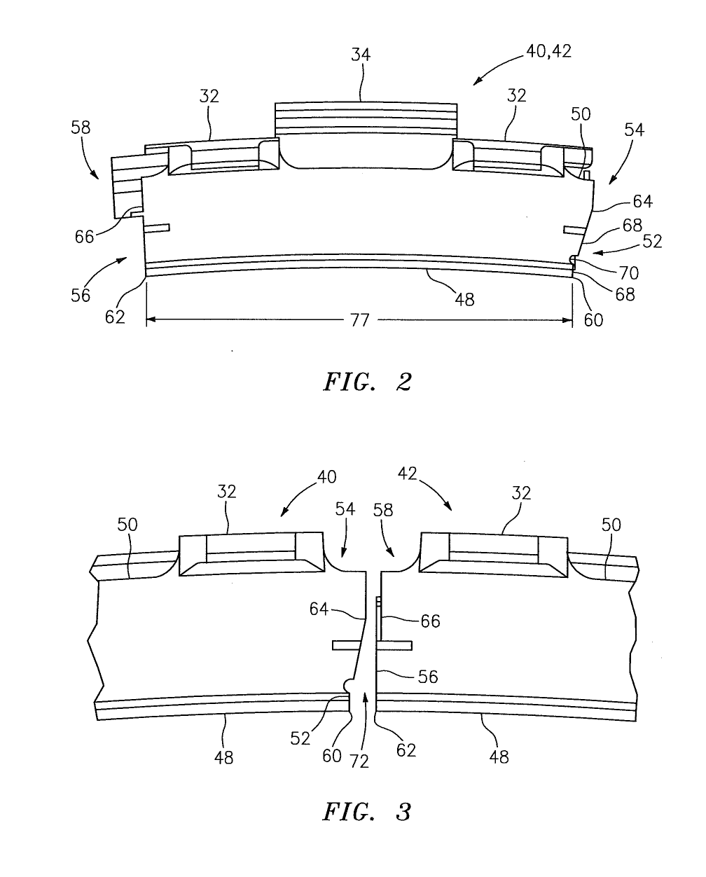

Referring to FIGS. 1 to 3, the blade outer air seal 16 includes a plurality of arcuate seal segments 40 and 42. Each seal segment 40, 42 extends axially between an upstream end 44 and a downstream end 46 (see FIG. 1). Each seal segment 40, 42 extends radially between a gas path surface 48 and a cooling gas surface 50. Referring to FIGS. 2 and 3, each seal segment 40, 42 extends circumferentially between a first confronting face 52 at a first segment end 54 and a second confronting face 56 at a second segment end 58. The first confronting face 52 extends between an inner radial end 60 and an outer radial end 64. The second confronting face 56 extends between an inner radial end 62 and an outer radial end 66. In the specific embodiment shown in FIG. 2, the first confronting face 52 is defined by circumferentially outer surfaces 68 of a pair of axially extending rails, which define a groove 70 therebetween. The groove 70 is provided, for example, as an outlet flow path for cooling air that is distributed through the seal segment from the cooling gas plenum 38.

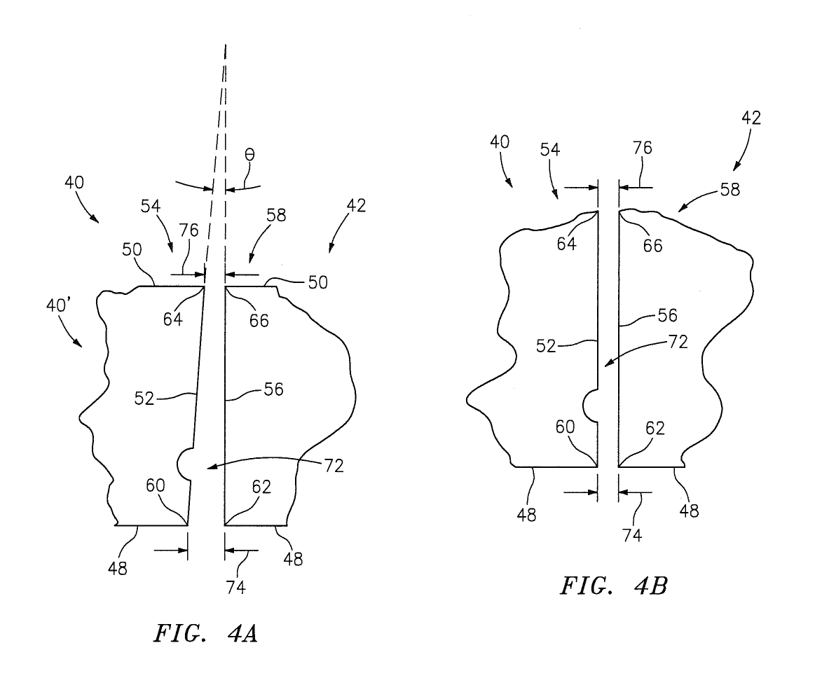

Referring to FIG. 3, adjacent seal segments 40 and 42 in the blade outer air seal 16 are arranged such that the first confronting face 52 of a first one of the adjacent seal segments 40 (hereinafter the “first seal segment”) is positioned adjacent the second confronting face 56 of a second one of the adjacent seal segments 42 (hereinafter the “second seal segment”) defining an intersegment gap 72 therebetween. Referring to FIGS. 4A and 4B, the gap 72 has an inner radial gap width 74 and an outer radial gap width 76. The inner radial gap width 74 extends circumferentially between the inner ends 60 and 62 of the first and second confronting faces 52 and 56. The outer radial gap width 76 extends circumferentially between the outer ends 64 and 66 of the first and second confronting faces 52 and 56. The gap 72 is provided to prevent or substantially reduce destructive interference between the seal segments 40 and 42 caused by seal segment deformation, while also reducing or preventing gas leakage therethrough.

Referring to FIGS. 1 and 2, each seal segment 40, 42 can be subject to thermal defog nation during engine operation. Relatively hot working gas, for example, is directed through the hot gas flow path 30, and relatively cool cooling gas is directed into the cooling gas plenum 38. The hot gas surface 48 of each seal segment 40, 42 therefore is subject to relatively high temperatures, whereas the cooling gas surface 50 is subject to relatively low temperatures. This temperature differential between the surfaces 48 and 50 defines a temperature distribution profile for each seal segment 40, 42. The term “temperature distribution profile” is used herein to describe at least a radial component of a temperature gradient through each seal segment 40, 42; i.e., a radial temperature gradient between the hot gas surface 48 and the cooling gas surface 50. Referring to FIG. 2, the temperature differential can cause thermal expansion and/or thennal warping of the seal segments 40 and 42 depending on the temperature distribution profile. Thermal expansion can increase a circumferential width 77 of each seal segment between the first and the second confronting faces 52 and 56. Thermal warping can reduce the curvature of (e.g., flatten) each seal segment.

Referring again to FIGS. 1 and 2, each seal segment 40, 42 can also be subject to pressure deformation during engine operation. The working gas directed through the hot gas flow path 30, for example, is typically provided at a lower pressure than the cooling gas directed into the cooling gas plenum 38. A differential pressure force therefore is exerted by the cooling gas onto the cooling gas surface 50 of each seal segment 40, 42. The term “differential pressure force” is used herein to describe a pressure force that results from a pressure differential between the working gas and the cooling gas. Referring to FIG. 2, the differential pressure force can cause, for example, the first and the second confronting faces 52 and 56 to warp (e.g., turn) radially inwards or outwards, depending on the configuration of the mounting flanges 32 and 34 and, in particular, which mounting flanges bear the greatest loads and/or act as pivot points. Referring to FIG. 5A, for example, where a seal segment 78 is centrally supported by mounting flanges 80, a pressure force exerted into the page against the segment 78 will cause its edges 82 and 84 to warp into the page since a majority of the force is acting on the segment 78 outside of a central triangular region 86. Referring to FIG. 5B, where a seal segment 88 is supported by mounting flanges 90 at its center and edges, on the other hand, a pressure force exerted into the page against the segment 88 will cause its upper corners 92 to warp out of the page since a majority of the force is acting on the segment 88 within a central triangular region 94. The differential pressure force in combination with the configuration of the mounting flanges defines a pressure distribution profile for each seal segment. The term “pressure distribution profile” is used herein to describe how a seal segment deforms in response to a differential pressure force applied thereon.

Referring to FIGS. 4A and 4B, in order to compensate for such thetinal and pressure deformation while reducing gas leakage through the gap 72, the seal segments 40 and 42 are configured such that the gap 72 has a non-uniform radial cross-sectional geometry at a first engine operating point (see FIG. 4A), and a substantially uniform radial cross-sectional geometry at a second engine operating point (see FIG. 4B). In this manner, the seal segments 40 and 42 can be designed for relatively high or maximum performance at the second engine operating point. The seal segments 40 and 42, for example, can be configured to significantly reduce or minimize gas leakage through the gap 72 at the second engine operating point, while still preventing destructive interference between adjacent segments. An example of a first engine operating point is where the engine is resting or is operating at a relatively low power setting (e.g., during taxiing or cruising). An example of a second engine operating point is where the engine is operating at a relatively high or maximum power setting (e.g., during takeoff). Each seal segment 40, 42 has a first temperature distribution profile and a first pressure distribution profile at the first engine operating point. Each seal segment 40, 42 has a second temperature distribution profile and a second pressure distribution profile at the second engine operating point, which second profiles are different than the first profiles.

Referring to FIG. 4A, the gap 72 has the non-uniform radial cross-sectional geometry where the first confronting face 52 of the first seal segment 40 is radially non-parallel to the second confronting face 56 of the second seal segment 42. In the specific embodiment shown in FIG. 4A, for example, the outer end 64 of the first confronting face 52 extends circumferentially beyond its inner end 60 such the first confronting face 52 has a substantially linear cross-sectional geometry that is skewed, via an offset angle θ, relative to a substantially linear cross-sectional geometry of the second confronting face 56. Examples of suitable offset angles θ range from, for example, approximately 1 to 20 degrees. The inner gap width 74 therefore is greater than the outer gap width 76. The present invention, however, is not limited to the aforesaid linear confronting faces. In alternative embodiments, for example, at least one of the confronting faces can have a non-linear (e.g., a parabolic, logarithmic, compound, etc.) cross-sectional geometry designed, for example, as a function of the seal segments' material expansion and strength properties.

Referring to FIG. 4B, the gap 72 has the substantially uniform radial cross-sectional geometry where the first confronting face 52 of the first seal segment 40 is substantially radially parallel to the second confronting face 56 of the second seal segment 42. In the specific embodiment shown in FIG. 4B, for example, the first confronting face 52 has a substantially linear cross-sectional geometry that is substantially parallel to a substantially linear cross-sectional geometry of the second confronting face 56. The inner gap width 74 therefore is substantially equal to the outer gap width 76. The present invention, however, is not limited to the aforesaid configuration. In alternative embodiments, for example, the confronting faces can have substantially parallel, non-linear cross-sectional geometries (e.g., uniform curving lines, etc.).

Referring to FIGS. 4A and 4B, during engine operation, the seal segments 40 and 42 can be subject to thermal and pressure deformation (e.g., thermal expansion, thermal warping, pressure warping, etc.) as described above where, for example, the power setting is increased from the first engine operating point to the second engine operating point. The inner ends 60 and 62 of the confronting faces 52 and 56, for example, circumferentially expand at a faster rate than the outer ends 64 and 66 as the temperature differential increases between the hot gas and cooling gas surfaces 48 and 50 (see FIG. 1). The difference in the magnitude of the thermal expansion can (i) cause adjacent confronting faces 52 and 56 to pivot towards each other, and (ii) flatten the curvature of each seal segment 40, 42. The flattening of the curvature, however, can be at least partially reduced where, for example, the differential pressure force acting on the cooling gas surface 50 (see FIG. 1) increases and thereby forces the first and the second segment ends 54 and 58 radially inwards. The combination of such thermal and pressure deformation therefore can change the cross-sectional geometry of the gap 72 from, for example, the non-parallel geometry shown in FIG. 4A at the first engine operating point to the substantially parallel geometry shown in FIG. 4B at the second engine operating point.

In addition to aligning the first and the second confronting faces 52 and 56 as shown in FIG. 4B, the deformation also decreases a minimum gap width between the adjacent seal segments. The term “minimum gap width” is used herein to describe the smallest circumferential distance between adjacent confronting faces. Referring to FIG. 4A, for example, the minimum gap width is equal to the outer gap width 76. Referring to FIG. 4B, the minimum gap width is equal to the inner and the outer gap widths 74 and 76. By decreasing the minimum gap width, the blade outer air seal 16 reduces gas leakage between adjacent seal segments 40 and 42 at the second engine operating point, which can increase engine efficiency.

While various embodiments of the present invention have been disclosed, it will be apparent to those of ordinary skill in the art that many more embodiments and implementations are possible within the scope of the invention. For example, the aforesaid principles can also be applied to compensate for an axial temperature and pressure distribution across the seal segments. Accordingly, the present invention is not to be restricted except in light of the attached claims and their equivalents.

What is claimed is:

1. A blade outer air seal for a gas turbine engine, comprising:
an arcuate first seal segment that extends circumferentially to a first confronting face; and
an arcuate second seal segment that extends circumferentially to a second confronting face;
wherein the first confronting face is positioned adjacent the second confronting face defining a gap therebetween;
wherein the confronting faces are radially non-parallel at a first engine operating point where each seal segment has a first temperature distribution profile and a first pressure distribution profile; and
wherein the confronting faces are substantially radially parallel at a second engine operating point where each seal segment has a second temperature distribution profile and a second pressure distribution profile, which first temperature distribution profile is different than the second temperature distribution profile, and which first pressure distribution profile is different than the second pressure distribution profile.

2. The blade outer air seal of claim 1, wherein a minimum gap width is defined circumferentially between the first and the second confronting faces, which minimum gap width is larger at the first engine operating point than at the second engine operating point.

3. The blade outer air seal of claim 1, wherein:
an inner gap width is defined circumferentially between radially inner ends of the confronting faces;
an outer gap width is defined circumferentially between radially outer ends of the confronting faces; and
the inner gap width is greater than the outer gap width at the first engine operating point.

4. The blade outer air seal of claim 1, wherein the first confronting face has a substantially linear cross-sectional geometry at the first engine operating point.

5. The blade outer air seal of claim 4, wherein the first confronting face extends between a radially outer end and a radially inner end, which outer end extends circumferentially beyond the inner end at the first engine operating point such that the first confronting face is skewed, via an offset angle, relative to the second confronting face.

6. The blade outer air seal of claim 5, wherein the first confronting face comprises outer surfaces of a pair of axially extending rails that define a groove therebetween.

7. A blade outer air seal for a gas turbine engine, comprising:
an arcuate first seal segment that extends circumferentially to a first confronting face; and
an arcuate second seal segment that extends circumferentially to a second confronting face;
wherein the first confronting face is positioned adjacent the second confronting face defining a gap therebetween;
wherein the gap varies radially at a first engine operating point where each seal segment has a first temperature distribution profile and a first pressure distribution profile; and
wherein the gap is substantially radially uniform at a second engine operating point where each seal segment has a second temperature distribution profile and a second pressure distribution profile, which first temperature distribution profile is different than the second temperature distribution profile, and which first pressure distribution profile is different than the second pressure distribution profile.

8. The blade outer air seal of claim 7, wherein a minimum gap width is defined circumferentially between the first and the second confronting faces, which minimum gap width is larger at the first engine operating point than at the second engine operating point.

9. The blade outer air seal of claim 7, wherein:
an inner gap width is defined circumferentially between radially inner ends of the confronting faces;
an outer gap width is defined circumferentially between radially outer ends of the confronting faces; and
the inner gap width is greater than the outer gap width at the first engine operating point.

10. The blade outer air seal of claim 7, wherein the first confronting face has a substantially linear cross-sectional geometry at the first engine operating point.

11. The blade outer air seal of claim 10, wherein the first confronting face extends between a radially outer end and a radially inner end, which outer end extends circumferentially beyond the inner end at the first engine operating point such that the first confronting face is skewed, via an offset angle, relative to the second confronting face.

12. The blade outer air seal of claim 11, wherein the first confronting face comprises outer surfaces of a pair of axially extending rails that define a groove therebetween.

13. A blade outer air seal for a gas turbine engine, comprising:
an arcuate first seal segment that extends circumferentially to a first confronting face; and
an arcuate second seal segment that extends circumferentially to a second confronting face;
wherein the first confronting face is positioned adjacent the second confronting face defining a gap therebetween, which gap has a radially inner gap width and a radially outer gap width;
wherein the inner gap width is greater than the outer gap width at a first engine operating point where each seal segment has a first temperature distribution profile and a first pressure distribution profile; and
wherein the inner gap width is substantially equal to the outer gap width at a second engine operating point where each seal segment has a second temperature distribution profile and a second pressure distribution profile, which first temperature distribution profile is different than the second temperature distribution profile, and which first pressure distribution profile is different than the second pressure distribution profile.

14. The blade outer air seal of claim 13, wherein:
the inner gap width extends circumferentially between radially inner ends of the confronting faces; and
the outer gap width extends circumferentially between radially outer ends of the confronting faces.

15. The blade outer air seal of claim 13, wherein a minimum gap width is defined circumferentially between the first and the second confronting faces, which minimum gap width is larger at the first engine operating point than at the second engine operating point.

16. The blade outer air seal of claim 13, wherein the first confronting face has a substantially linear cross-sectional geometry at the first engine operating point.

17. The blade outer air seal of claim 16, wherein the first confronting face extends between a radially outer end and a radially inner end, which outer end extends circumferentially beyond the inner end at the first engine operating point such that the first confronting face is skewed, via an offset angle, relative to the second confronting face.

18. The blade outer air seal of claim 17, wherein the first confronting face comprises outer surfaces of a pair of axially extending rails that define a groove therebetween.
